(19) United States
(12) Patent Application Publication
(10) Pub. No.: US 2013/0069947 A1
(43) Pub. Date: Mar. 21, 2013

(54) CALCULATING DISPLAY SETTINGS AND ACCURATELY RENDERING AN OBJECT ON A DISPLAY

(71) Applicants: Justin J. Berstler, Durham, NC (US); Ian C. Tewksbury, Morrisville, NC (US); Jianjun Zhang, Cary, NC (US)

(72) Inventors: Justin J. Berstler, Durham, NC (US); Ian C. Tewksbury, Morrisville, NC (US); Jianjun Zhang, Cary, NC (US)

(73) Assignee: INTERNATIONAL BUSINESS MACHINES CORPORATION, Armonk, NY (US)

(21) Appl. No.: 13/237,580

(22) Filed: Sep. 20, 2011

(51) Int. Cl. G06T 3/40

(52) U.S. Cl. 345/428

(57) ABSTRACT

In one embodiment, a system for displaying parameters of an original object on a display is described. The system includes a user interface that displays data. The system further includes a system for calculating pixels per distance and displaying parameters of an image on the display device. The system calculates the pixels per distance ratio by displaying a width and height parameter on the display and adjusting the width and height parameter to correspond to a standard sized object. The system calculates the pixels per distance ratio based on the adjusted width and height parameters. The system is further configured to receive an image from a provider to for display. At least one parameter of the image from the provider as displayed corresponds to at least one parameter of the original object. The corresponding parameters of the image and original object share approximately the same geometric dimensions.

### BACKGROUND

There are many applications which use interaction between electronic displays. One application is to display objects or images on a display. In displaying images on an electronic display, conventional systems often scale resolution or display settings to more accurately portray actual sized depictions of objects in order to get accurate information about that object, such as size, dimensions, or an accurate picture of what that object or image looks like. Other applications include displaying objects or images on an electronic display and rendering an actual sized replication of that image on another display device.

Rendering actual sized objects on an electronic display is often difficult without knowing specific settings of that display device. On conventional electronic displays, display settings are generally different between multiple display devices. Specifically, some displays portray their images at different pixilation settings and scaling measurements. For example, while one device may display images at a resolution of 100 pixels per inch, another device may display images at a ratio of 80 pixels per inch. If an image were transferred directly between these displays, the two displays would not depict images with the same geometric dimensions. Also, in some display devices, displays of images are affected by physical properties of the device, including age of the device and advances in technology between interacting devices. Further, it is not always easy to discover pixilation settings on different devices to make necessary adjustments, and it is even more difficult to have conformity between multiple devices.

### SUMMARY

Embodiments of a system are described. In one embodiment, the system is a system for displaying parameters of an original object on a display. The system includes a user interface that displays data. The system further includes a system for calculating pixels per distance and displaying parameters of an image on the display device. The system calculates the pixels per distance ratio by displaying a width and height parameter on the display and adjusting the width and height parameter to correspond to a standard sized object. The system calculates the pixels per distance ratio based on the adjusted width and height parameters. The system is further configured to receive an image from a provider to display on the display device. At least one parameter of the image from the provider as displayed corresponds to at least one parameter of an original object. The corresponding parameters of the image and original object share approximately the same geometric dimensions.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of a system for accurately replicating and displaying objects on an electronic display.

FIG. 2 depicts a schematic diagram of a device for accurately replicating and displaying objects on an electronic display.

FIG. 3 depicts a representation of a display at the beginning of the calibration process.

FIG. 4A depicts a representation of a display during the calibration process with resized calibration dimensions.

FIG. 4B depicts a representation of a display at the completion of the calibration process after calibration dimensions have been resized.

FIG. 5 depicts a method for calculating the display settings of a device and accurately portraying a replication of an object on a display.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some embodiments include a device for receiving input parameters of an object or image to be replicated and displayed on a display device. The device performs a calibrating process of measuring the number of pixels per distance on a display device, and calculating a pixels per distance ratio of that particular display device. The device receives input parameters of an object or image and scales the parameters according to the pixel per distance ratio calculated during calibration of the display device. A replication of the object or image is then generated and displayed on the display device with geometric dimensions corresponding to the actual size of the input parameters of the image or object. By way of example, input parameters of an original object or image may be one or more dimensions, a common shape, a shape accompanied by measurements, a standard unit of distance, an image or object of specified dimensions, an entry from a database of objects or images, or any parameters of objects or images that may be replicated and displayed on a display device.

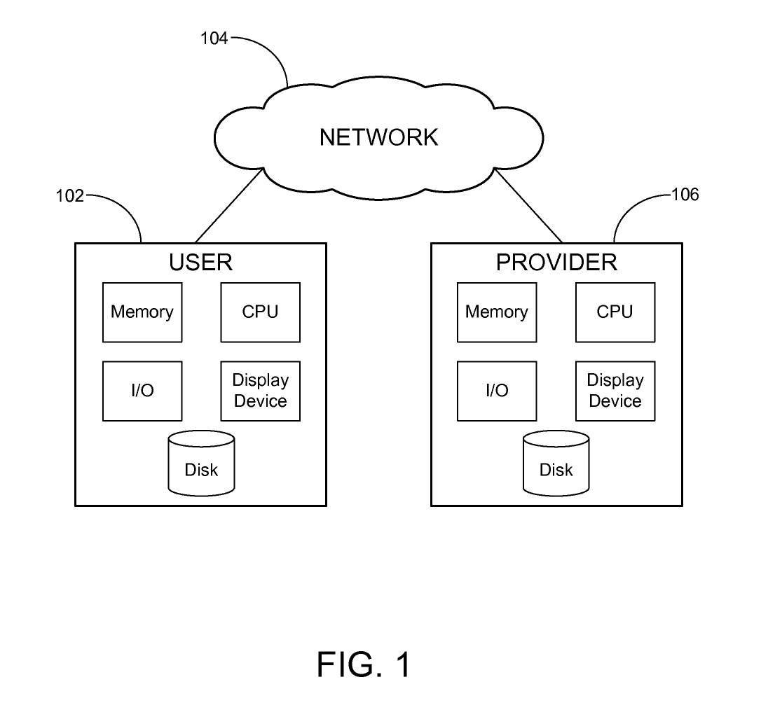

FIG. 1 depicts a schematic diagram of a system 100 for accurately replicating and displaying object parameters on an electronic display. The system 100 includes a user device 102 and a provider device 106 that interact over a network 104. The network 106 may be any type of network for communication between multiple devices, such as a LAN, WLAN, intranet, Internet, or combination thereof. Further, the illustrated devices 102, 106 include a number of components, such as a processor, memory, I/O device, display, storage disk, or combination thereof.

In calculating display settings and replicating an image on a display, a user or provider 102, 106 may begin by calculating the number of pixels per distance (PPD) of a particular display device. This is done through a calibration process of putting a standard sized item, such as a credit card, up to a display and changing calibration measurements to correspond to the size of the standard item. A processor will then determine the number of pixels per distance on a display. At this step, a user or provider 102, 106 uses the pixel calculations and renders an image or object of known dimension and size on a display according to the geometric dimensions of the actual image or object. This image or object replication may be displayed on the display of a user or provider device 102, 106.

In some embodiments of the system 100, a user 102 and a provider 106 may contribute to the calculation of display settings and rendering of the image at different stages of the process. In some embodiments, the entire system 100 may be contained within a user device 102, including calculating PPD settings and rendering a replication of the object on the display. In other embodiments, tasks may be divided between a user 102 and a provider 106 with a user 102 providing dimensions and images to be replicated and a provider 106 performing tasks of calculating display settings and replicating the objects for display. In other embodiments, the system 100 may include fewer or more components to implement less or more functionality.

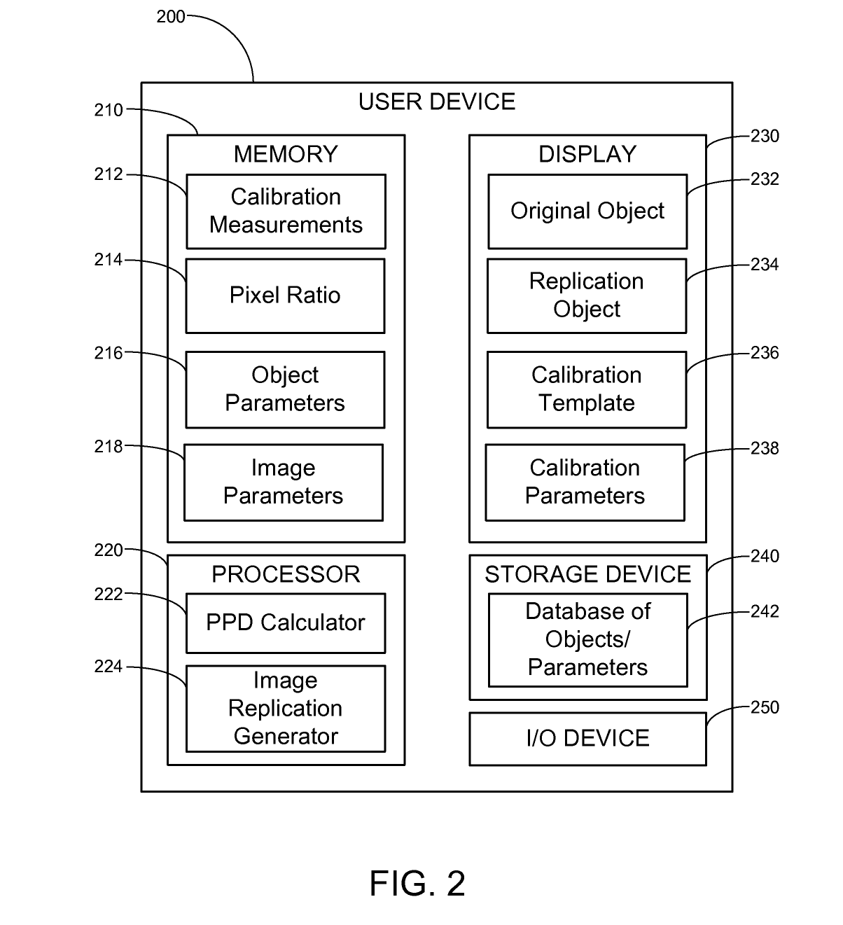

FIG. 2 depicts a schematic diagram of a device 200 for accurately replicating and displaying objects on an electronic display. The device 200 includes a memory component 210. The memory 210 includes values and/or instructions that are used by a processor 220 for instructing other components of the device 200 to operate according to software commands. For example, the memory 210 includes calibration measurements 212 for calculating the display settings of the device 200. Specifically, these calibration measurements 212 are for calculating display and pixel settings, including a pixel ratio 214. The pixel ratio 214 is generally a pixel per standard distance measurement unit, and provides a parameter that allows a geometrically accurate depiction of an object. For example, if a pixel ratio 214 is found to be 100 pixels per inch, that pixel ratio 214 may be used to accurately depict an object with a width of 1.50 inches on a display 230 by displaying an object that has a width of 150 pixels.

After calibrating the display 230 and/or calculating the pixel ratio 214, the memory 210 also provides some values for replicating and rendering an object or an image on a display 230. A user 102 may provide object dimensions 216 manually or by providing an image to the device 200 accompanied by object dimensions 216. In some embodiments, a device 200 may receive an object to be displayed within an image or accompanied by a second image, in an application where it may be useful to separate the object from an image with different scaling properties. For example, if an object were superimposed on a background image, it may be useful to isolate and scale the dimensions of the object 216 without changing the accompanying image dimensions 218. In this case, the memory 210 may store and make available separate object dimensions 216 and image dimensions 218 should it become useful for an object and image to be separated in the replication and display process. This could be done initially upon submission of dimensional data to the device 200 or it could be done after display of an image and object by drawing a box or outline around an object and defining a new object or separating the object within the box or outline from the accompanying image.

The device 200 further includes a processor 220 for performing the necessary operations of the system 100 and instructing components within the device 200 to provide, store, and display data as instructed. When given software instructions, the processor 220 processes and executes instructions on a PPD calculator 222 and an image replication generator 224. During the calculation of display settings, the PPD calculator 222 receives calibration measurements 212 and calculates a pixel ratio 214 for use during replication of the parameters an object or image. After calculation of the pixel ratio 214, the image replication generator 224 uses the pixel ratio 214 and generates a replication image 234 scaled to the number of pixels representing the geometric dimensions of an original object 232.

The device 200 also includes a display 230 on which an original object 232 and/or a replication object 234 may be displayed. Initially, during the calibration process, the display 230 displays a calibration template 236 and calibration parameters 238. In calibrating the device 200, the display 230 first displays a calibration template 236 which may correspond to the approximate size of a standard sized item, such as a credit card. A user may hold the credit card up to the display 230 and change calibration parameters 238 to match the dimensions of the standard sized item. A user may change the calibration parameters 238 by manually changing the parameters with a cursor on the display 230 or through another component of a user interface, such as a keyboard, mouse, joystick, touch screen or other input device. The device 200 then instructs the processor 220 to calculate the pixel ratio 214 of the display device 230. The pixel ratio 214 provides a parameter for converting geometric dimensions into number of pixels, which will be used by the device 200 for replicating an object or image to the display 230.

In at least one embodiment, rather than replicating an image with scaled dimensions, a processor 220 may calibrate the display settings of a device 200 to settings where images most closely correspond to actual sized objects. In this instance, after a display 230 has been calibrated, every object displayed on the device 200 will closely approximate the geometric size of the object as it was transmitted to the device 200. In other embodiments, this calibration process would be used to calibrate the display settings of a device 200 to duplicate or mimic the display settings of a second device with a display. In this case, objects or images transferred between display devices 230 would match one another in pixels per inch, and therefore mimic each other's geometric dimensions. This would be useful, for example, where a provider 106 lacks the functionality of rescaling an image according to the pixel ratio 214 and would rather transfer an image to a user 102 that has identical display settings. This would also facilitate easy transfers of images between two or more familiar devices that are frequently used for transferring images to each other without expending the processing power of replicating an object according to the PPD measurements obtained in alternate calibration processes.

After calibration of the display 230 and/or calculation of the pixel ratio 214, the display 230 may then accurately display a replication object 234 with corresponding geometric dimensions to the original object 232. Because the device 200 recognizes the accurate pixels per distance of the display 230, the dimensions of the replication object 234 should be approximately equal to the dimensions of the original object.

The device 200 may also include a storage device 240. The storage device 240 may be implemented to store any of the values from the memory 210 or data from the processor 220 for use by the device 200. In some embodiments described herein, specifically regarding the functionality of the memory 210 in providing data, some functions of the memory device 210 in storing data may be accomplished by the storage device 240. In one embodiment, the storage device 240 includes a database of object parameters 242 with known dimensions and sizes. This may be provided by a user 102 or a provider 106 depending on the application of the device 200. If, for example, a user wants to see the parameters of a commonly used or specific object, the user 102 may replicate the dimensions or a depiction of that object from a database of object parameters 242 stored on a storage device 240.

In some embodiments, this database of object parameters 242 could be a list of objects with dimensions commonly used by a user 102 or provider 106. A user 102 or provider 106 could make additions or edits to the database of objects 242 in a dynamically updating process to further expand the entries of the database 242. In another embodiment, the database of object parameters 242 could be a list of simple dimensions or shapes where a user 102 could command a device 200 to draw a simple line or shape with certain dimensions without relying on a physical object or image. In another embodiment, the database of object parameters 242 could be a list of products for distribution or manufacture by a provider or other third party, where a replication of that product may be shown on the display 230 with corresponding accurate geometric dimensions.

In some embodiments, a user 102 or provider 106 could provide a database of pixilation settings of different displays 230. This would allow a device 200 to create replications of objects on a display 230 while foregoing the calibration process of putting a standard object to the screen and adjusting the calibration parameters 238. If, for example, a user 102 or provider 106 lacked the calibration software or had already used the calibration software in prior interactions with a provider 106, the provider 106 would be able to send an accurately sized depiction based on the model or known settings of the particular user display 230 without recalibrating each time.

In other embodiments, the storage device 240 may include a database of known screen sizes, either of known display settings or screen sizes from multiple mobile devices. If a user 102 desires to transfer an actual sized screen shot of a mobile device, the user 102 would be able to render an actual sized replication of the mobile screen without the need to provide dimensions to the image rendering software. This would be accomplished by calculating the pixel ratio 214 of the user device 200 and then drawing upon known dimensions of a particular mobile device from a database of object parameters 242 on the storage device 240. This would be a useful feature for a user 102 or provider 106 that makes multiple transfers between display devices thereby eliminating the need to recalibrate and re-enter dimensions every time a user wants to replicate the actual size or parameters of an original object or image 232 on a display 230.

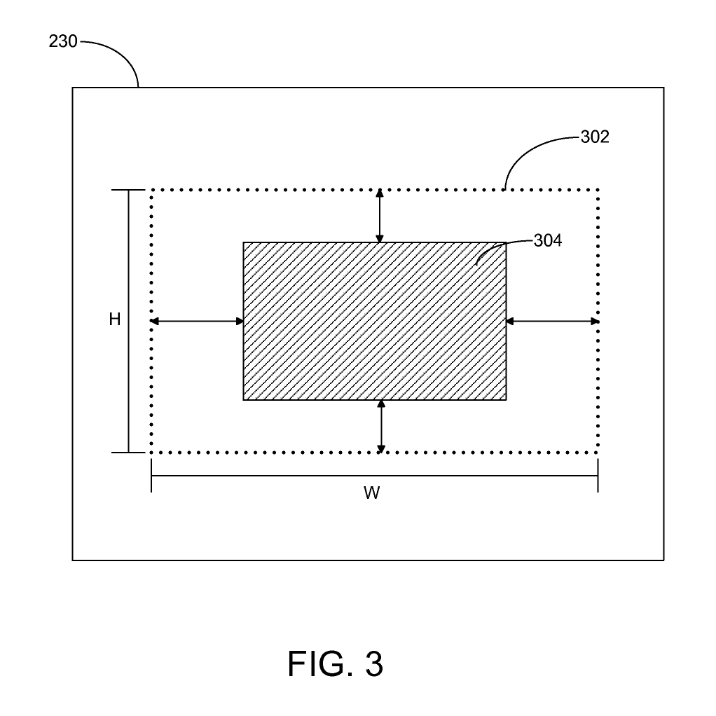

FIG. 3 depicts a visual representation of a display 230 initializing the calibration process. At the beginning of calibration, the display 230 displays a calibration frame 302 portrayed as a rectangular frame on the display 230. The calibration frame 302 will initially correspond to the dimensions of a calibration template 236 and in some embodiments be an approximation a standard object 304. The device 200 prompts the user 102 to place a standard sized object 304 to the display 232 and compares the standard object 304 to the calibration frame 302 to determine if the calibration parameters 238 need to be changed in order to accurately calculate a pixel ratio 214. In the illustrated embodiment, the calibration frame 302 is notably larger than the standard object 304 and will need to be scaled in order to calculate a pixel ratio 214 of the display 230.

The standard object 304 may be any object of known size and dimensions. In one embodiment, the standard object 304 is a credit card, which is generally the same size on a global scale. Other standard objects 304 may be different types of paper currency, coins, cards, ruler measurements, or any other objects where the dimensions are generally uniform across at least a minimal demographic of multiple users. A standard object 304 should be such that the dimensions of the object 304 may be stored by the user 102 or provider 106 on a device 200 and used for calculation of a pixel ratio 214.

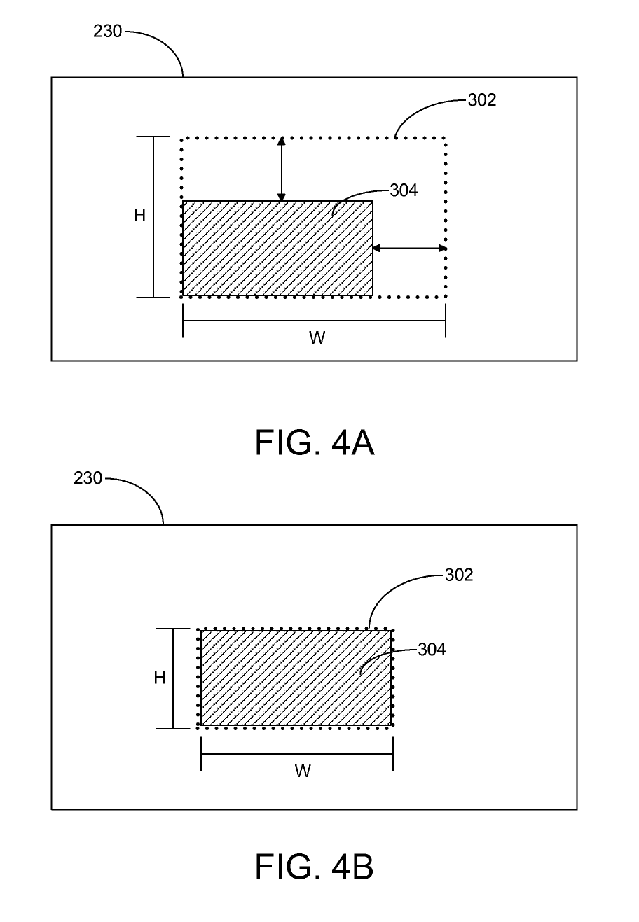

FIG. 4A depicts a visual representation of a display 230 during the calibration process where dimensions of the calibration frame 302 have been rescaled. In the illustrated display 230, the calibration frame 302 is larger than the standard object 304. On other displays, the calibration frame 302 may be smaller or approximately equal to the standard object 304 depending on the settings of the display 230. Because the calibration frame 302 is larger than the standard object 304, the left and bottom parameters of the calibration frame 302 have been scaled to line up with the left and bottom parameters of the standard object 304. In some embodiments, the left and right parameters of the calibration frame 302 may be fixed while allowing a user to rescale only the total width or height parameters of the calibration frame 302. In this case, a user 102 would place the standard object 304 on the display 230 to line up approximately with a corner of the calibration frame 302. This would eliminate some steps of scaling four or more sides of the calibration frame 302 throughout the calibration process.

FIG. 4B depicts a visual representation of a display 230 at completion of the calibration process where dimensions of the calibration frame 302 have been rescaled to approximate the size of the standard object 304. In the illustrated display 230, the top and right parameters of the calibration frame 302 have been rescaled to line up with the top and right parameters of the standard object 304 so as to approximate the same geometric dimensions of the standard object 304. At this point, a user 102 or provider 106 may issue a command for the processor 220 to calculate the pixel ratio 214 of the display 230. The PPD calculator 222 will determine how many pixels represent the dimensions of the known standard object 304 and determine the pixel ratio 214 of the display 230 for later use in rendering accurate replications of objects.

In some embodiments, the calibration process may implement the resizing of a rectangular calibration frame 302 similar to the illustrated depictions of FIGS. 3A-3B. In other embodiments, the calibration frame 302 may be one dimensional, only measuring the length of one side of a standard object 304 for calibration purposes. Because many displays have square pixels, it may only be necessary to scale the calibration frame 302 to line up with the width, height, or single side of a standard object 304 so long as the width, height, or single side of the object 304 is a standard dimension. In this case, it may be possible to calibrate the display 230 by holding a ruler up to the display 230, or scaling the calibration frame 302 to line up with a single side of a credit card, thus simplifying the calibration process in some embodiments.

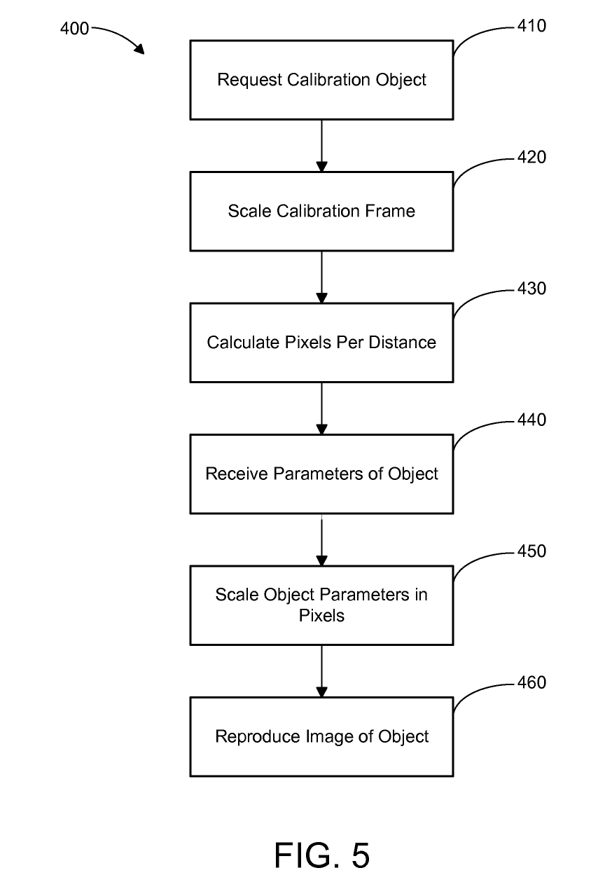

FIG. 5 depicts a method 400 for calculating the display settings of a device 200 and accurately portraying an object on a display. In the disclosed method 400, one particular process is discussed for calculating the display settings and accurately replicating an object to be displayed, and may include other features and operations discussed in relation to other figures and embodiments.

The user or provider device 200 begins a calibration process by requesting 410 a calibration object. This is done with a prompt of displaying the calibration template on the display and giving the user 102 an opportunity to place a standard sized item 304, such as a credit card, up to the screen. This may be done entirely on a user device 200 or through an interface with a provider 106 if the user 102 doesn't have the precise software installed on the user device 200.

After placing the standard sized object 304 on the display 230, a user 102 scales 420 a calibration frame 302 to reflect the dimensions of the standard sized object 304. A user 102 may do this with a cursor by clicking and moving the various bounds of the calibration frame 302 to line up with the borders of the standard sized object 304. In some embodiments, for example, where the pixels of a display 230 are square, a user 102 may only need to scale the calibration frame 302 to line up with one of the width, height, or side of the standard object 304, so long as that dimension is known and uniform to that particular object.

Once the calibration frame 302 is lined up with the standard object 304, the user 102 may indicate to the processor 220 to calculate 430 the PPD ratio 214 of the user device 200. This is done by calculating the number of pixels along the calibration frame 302. Because a user 102 has scaled 420 the calibration frame 302 to a known set of dimensions corresponding to the standard object 304, the processor 220 may assume that the number of pixels along the edge of the calibration frame 302 also corresponds to the geometric distance of the width, height, and/or surface of the standard object. The system 100 may then use that PPD ratio 214 of the user device 200 to display a replication of an object 234 on the display 230 with accurate dimensions corresponding to the actual size of the original object 232.

After calibration of a display 230 has been performed, the user or provider device 200 then receives 440 input parameters of an original object 232 provided by a user 102 or provider 106. These object parameters 216 may be provided from a user 102 or provider 106 by manually entering or retrieving measurements from a storage database of an object to be displayed. The object parameters 216 may also be provided via scanning an object or image to a device 200 and receiving the parameters 216 from the scanner. In some embodiments, the parameters 216 of an object may be provided by a storage device 240 with access to a database of objects 242. These may be common objects frequently used by the user 102 or provider 106 or may be a database 242 that is frequently updated by a user 102 or provider 106 to meet their specific needs. For example, if a user 102 were to specifically request that a standard mechanical tool were to be displayed, a provider 106 of mechanical tools would be able to draw from a database of mechanical tools with known dimensions, and send those dimensions to the processor 220 for generating an image of a particular tool. Another example would be a database of multiple electronic devices, including different types of displays. This could be provided by a user 102, provider 106, or by information transmitted via a network 104, such as the Internet, and a processor 220 could be configured to receive 440 parameters of an original object 216 from these and other sources.

Once the device 200 has calculated 430 the PPD and received 440 the dimensions of an original object 216, the processor 220 then scales 450 the dimensions of the original object 216 in pixels according to the pixel ratio 214 calculated 430 in the calibration process. Because the device 200 is now aware of how many pixels are required to render a geometrically accurate depiction of an image or object, the processor 220 may scale a replication of the original object 234 to the correct number of pixels as to accurately display that object in the correct geometric dimensions.

Once the device 200 has determined the parameters of an original object 216 in the correct number of pixels, the device reproduces 460 an image from the original object 232 and displays a replicated image 234 on a display 230. Because the calibration process was specifically implemented on the user display 230, the replication object 234 on the user display 230 should be an accurate depiction of the original object 232 sharing the same geometric dimensions. If, for example, a user 102 needed to use a standard 10 mm bolt, and possessed several bolts of different sizes, the user 102 could display a 10 mm bolt on the display 230 and compare the replication object 234 to the physical bolts in the user's possession. Because the replication object 234 is an actual sized depiction, the user 102 would be able to accurately determine which physical bolt was a 10 mm bolt.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a system for calculating the PPD of a display and accurately displaying an object or image includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer program product, comprising:
a computer readable storage medium to store a computer readable program, wherein the computer readable program, when executed by a processor within a computer, causes the computer to perform operations for displaying parameters of an original object on a display device, the operations comprising:
calculating a pixels per distance ratio of the display device, wherein calculating the pixels per distance ratio comprises;
displaying a width parameter or a height parameter on the display device;
adjusting the width parameter or the height parameter on the display device to correspond to a standard sized object; and
calculating the pixels per distance ratio for the display device based on the dimensions of the adjusted width and height parameters;
sending the pixels per distance ratio to a provider; and
receiving an image from the provider to be displayed on the display device, wherein at least one parameter of the image from the provider displayed on the display device corresponds to at least one parameter of the original object, wherein the corresponding parameters of the image and the original object share approximately the same geometric dimensions.

2. The computer program product of claim 1, wherein calculating a pixels per distance ratio on the display device further comprises:
prompting a user to place the standard sized object up to the display device; and
adjusting the width parameter or the height parameter on the display device to correspond to the width or height of the standard sized object.

3. The computer program product of claim 2, wherein the standard sized object placed up to the display device is a credit card.

4. The computer program product of claim 1, wherein the computer readable program, when executed on the computer, causes the computer to perform additional operations, comprising:
storing the pixel per distance ratio of the display device for use in future replication and displaying of original objects; and
recalling the stored pixel per distance ratio of the display device during subsequent replications and displaying of original objects.

5. The computer program product of claim 1, wherein the computer readable program, when executed on the computer, causes the computer to perform additional operations, comprising:
providing a database of parameters of original objects to be displayed, wherein the database of parameters of original objects comprises a list of parameters of original objects corresponding to geometric dimensions.

6. The computer program product of claim 5, wherein the database of parameters of original objects comprises a database of different display devices, the database of different display devices comprising a list of parameters of the different display devices.

7. The computer program product of claim 1, wherein the computer readable program, when executed on the computer, causes the computer to perform additional operations, comprising:
changing a display setting of the display device to mimic a corresponding display setting of a second device, wherein a parameter on the display device will approximately correspond to a parameter of similar dimensions on the second device.

8. A method for displaying parameters of an original object on a display device, comprising:
calculating a pixels per distance ratio of the display device, wherein calculating the pixels per distance ratio comprises;
displaying a width parameter and a height parameter on the display device;
adjusting the width parameter and the height parameter on the display device to correspond to a standard sized object; and
calculating the pixels per distance ratio for the display device based on the dimensions of the adjusted width and height parameters;
sending the pixels per distance ratio to a provider; and
receiving an image from the provider to be displayed on the display device, wherein at least one parameter of the image from the provider displayed on the display device corresponds to at least one parameter of the original object, wherein the corresponding parameters of the image and the original object share approximately the same geometric dimensions.

9. The method of claim 8, wherein calculating a pixels per distance ratio of the display device further comprises:
prompting a user to place the standard sized object up to the display device; and
adjusting the width parameter or the height parameter on the display device to correspond to the width or height of the standard sized object.

10. The method of claim 9, wherein the standard sized object placed up to the display device is a credit card.

11. The method of claim 8, further comprising:
storing the pixel per distance ratio of the display device for use in future replication and displaying of original objects; and
recalling the stored pixel per distance ratio of the display device during subsequent replications and displaying of original objects.

12. The method of claim 8, further comprising providing a database of parameters of original objects to be displayed, wherein the database of parameters of original objects comprises a list of parameters of original objects corresponding to geometric dimensions.

13. The method of claim 12, wherein the database of parameters of original objects comprises a database of different display devices, the database of different display devices comprising a list of parameters of the different display devices.

14. The method of claim 8, further comprising changing a display setting of the display device to mimic a corresponding display setting of a second device, wherein a parameter on the display device will approximately correspond to a parameter of similar dimensions on the second device.

15. A system for displaying parameters of an original object on a display device, comprising:
a user interface that displays data on the display device; and
a system for calculating a pixels per distance ratio and displaying parameters of an image on the display device, configured to:
calculate a pixels per distance ratio of the display device, wherein calculating the pixels per distance ratio comprises;
displaying a width parameter and a height parameter on the display device;
adjusting the width parameter and the height parameter on the display device to correspond to a standard sized object; and
calculating the pixels per distance ratio for the display device based on the dimensions of the adjusted width and height parameters;
send the pixels per distance ratio to a provider; and
receive an image from the provider to be displayed on the display device, wherein at least one parameter of the image from the provider displayed on the display device corresponds to at least one parameter of the original object, wherein the corresponding parameters of the image and the original object share approximately the same geometric dimensions.

16. The system of claim 15, wherein calculating the pixels per distance ratio further comprises:
prompting a user to place the standard sized object up to the display device; and
adjusting the width parameter or the height parameter on the display device to correspond to the width or height of the standard sized object.

17. The system of claim 15, wherein the system for calculating a pixels per distance ratio and displaying parameters of an image on the display device is further configured to:
store the pixel per distance ratio of the display device for use in future replication and displaying of original objects; and
recall the stored pixel per distance ratio of the display device during subsequent replications and displaying of original objects.

18. The system of claim 15, wherein the system for calculating a pixels per distance ratio and displaying parameters of an image on the display device is further configured to provide a database of parameters of original objects to be displayed, wherein the database of parameters of original objects comprises a list of parameters of original objects corresponding to geometric dimensions.

19. The system of claim 18, wherein the database of parameters of original objects comprises a database of different display devices, the database of different display devices comprising a list of parameters of the different display devices.

20. The method of claim 15, wherein the system for calculating a pixels per distance ratio and displaying parameters of an image on the display device is further configured to change a display setting of the display device to mimic a corresponding display setting of a second device, wherein a parameter on the display device will approximately correspond to a parameter of similar dimensions on the second device
